(19) United States
(12) Patent Application Publication
(10) Pub. No.: US 2012/0080852 A1
(43) Pub. Date: Apr. 5, 2012

(54) Seal Cartridge For A Centrifugal Pump

(76) Inventors: Kim M. Arnold, Draper, UT (US); James G. Shaw, Kaysville, UT (US); Amber Broderick, Lehi, UT (US)

(21) Appl. No.: 13/249,640

(22) Filed: Sep. 30, 2011

Related U.S. Application Data
(60) Provisional application No. 61/388,504, filed on Sep. 30, 2010.

(51) Int. Cl. F16J 15/16

(52) U.S. Cl. 277/370

(57) ABSTRACT

A seal cartridge assembly for installing the elements of a mechanical sealing arrangement in a rotodynamic pump provides, as part of the seal cartridge, a shaft sleeve that supports certain of the non-rotating elements of the sealing arrangement, and facilitates placement of the sealing elements by providing shearable pin elements.

### CROSS-REFERENCE TO RELATED APPLICATIONS

This is a non-provisional application which claims priority to U.S. provisional application Ser. No. 61/388,504, filed Sep. 30, 2010, the contents of which are incorporated herein, in their entirety, by reference.

### STATEMENT REGARDING FEDERALLY SPONSORED RESEARCH OR DEVELOPMENT

None.

### REFERENCE TO SEQUENCE LISTING, A TABLE, OR A COMPUTER PROGRAM LISTING COMPACT DISC APPENDIX

None.

### BACKGROUND OF THE INVENTION

1. Field of the Invention

This invention relates to rotodynamic pumps, and specifically relates to seal assemblies that are structured to facilitate the accurate installation of rotating and non-rotating seal elements relative to a rotating element and a stationary element of the pump.

2. Background of Related Art

Rotodynamic pumps, such as centrifugal pumps, are conventionally structured with a rotating element, such as an impeller or a rotor, that is positioned adjacent a non-rotating, or stationary element of the pump, such as a pump casing or housing. Typically, a sealing arrangement is provided which seals the rotating member relative to a stationary element of the pump to prevent leakage of fluid along the rotating element.

The sealing arrangement usually comprises a rotating seal member that is secured in some manner to and rotates with the rotating element, and a stationary seal member that is secured in some fashion to a stationary element of the pump. In many sealing arrangements, both the rotating seal member and the non-rotating seal member have a seal face which is positioned to engage with each other, thereby providing a fluid seal between the rotating and non-rotating elements.

The manner in which the sealing arrangement of a rotodynamic pump is installed in the pump varies among types of pumps. One conventional method of installing a seal assembly comprises positioning a non-rotating, or stationary, seal element about the rotating element of the pump, such as a drive shaft, using a positioning element. The rotating seal elements are then positioned about the drive shaft, followed by the positioning of a biasing spring that maintains the seal faces of the rotating seal member and non-rotating seal member in sealing engagement. This manner of serially assembling the seal member elements on the drive shaft has proven to be very difficult, inaccurate and time-consuming.

U.S. Pat. No. 4,815,747, the contents of which are incorporated herein by reference, describes an improved means for installing a sealing arrangement which involves assembling together the non-rotating and rotating sealing members, and positioning the sealing assemblage about the drive shaft using a support member. The support member supports both the rotating elements of the sealing arrangement and the non-rotating elements of sealing arrangement, the latter of which is supported on the support ring using a ring having frangible tabs that shear as the non-rotating element is installed in place against the stationary element.

While the use of a ring having frangible tabs as disclosed by U.S. Pat. No. 4,815,747 more readily facilitates the placement of the sealing arrangement in comparison with earlier methods of installation, the mechanism nonetheless is subject to failure since the integrity of the support member is compromised in an effort to accommodate the ring and frangible tabs. The failure of the support member results in improper operation of the pump, which is only determinable once the pump is fully assembled and in operation. The inaccurate placement of the seal assembly not only lessens the service life of the pump, but causes time-consuming and costly repair.

Thus, it would be beneficial to the art to provide an improved means for facilitating the installation of a sealing arrangement in a rotodynamic pump using a mechanism that improves the accuracy of the positioning and which does not compromise the integrity of the positioning elements that may otherwise lead to improper pump operation.

### BRIEF SUMMARY OF THE INVENTION

In accordance with one aspect of the present disclosure, a seal cartridge assembly for installing the elements of a sealing arrangement in a rotodynamic pump is provided. The seal cartridge assembly is structured to enable the installation of the rotating and non-rotating seal elements of the sealing arrangement in a single operation to facilitate accurate placement of the sealing arrangement.

In another aspect of the disclosure, the seal cartridge assembly includes a shaft sleeve that is structured to support the non-rotating and rotating seal elements of the sealing arrangement to facilitate installation of the sealing arrangement. The shaft sleeve is structured with shearable connectors that enable the attachment and carrying of a non-rotating seal element of the seal arrangement as the sealing arrangement is installed.

In another aspect of the disclosure, the shearable connectors are specifically constructed and associated with the shaft sleeve in a manner that maintains the integrity of the shaft sleeve, and thereby extends the service life of the shaft sleeve and the sealing mechanism. Additionally, the shearable connectors are specifically constructed to assure that the sealing arrangement is accurately positioned relative to the rotating element of the pump, such as the drive shaft.

In another aspect of the disclosure, the shearable connectors are specifically constructed to have sufficient strength to support the non-rotating seal elements of the sealing arrangement during installation of the sealing arrangement, and to shear or break at a selected shear force to assure complete and accurate positioning of the sealing arrangement. The specific construction of the shearable connectors assures balanced loading on the sealing arrangement.

These and other advantages of the seal cartridge assembly of the disclosure will become more apparent in the detailed description and illustrations that follow.

### BRIEF DESCRIPTION OF THE SEVERAL VIEWS OF THE DRAWINGS

In the drawings, which depict what is currently considered to be the best mode for carrying out the seal cartridge of the disclosure:

FIG. 1A is a view in cross section of a type of centrifugal pump illustrating the relative positioning of a drive shaft, impeller and sealing arrangement in a known pump arrangement;

FIG. 1B is an enlarged view of the sealing arrangement shown in FIG. 1A;

FIG. 2 is an enlarged view in cross section of the pump and drive shaft shown in FIG. 1, illustrating the initial installation of the non-rotating seal elements in a conventional installation;

FIG. 3 is an enlarged view in cross section of the pump and drive shaft shown in FIG. 1, illustrating the installation of the rotating seal elements;

FIG. 4 is a perspective view of a tubular support and stationary seal ring arrangement of a known pump disclosed in U.S. Pat. No. 4,815,747;

FIG. 5A is a view in cross section of a centrifugal pump depicting the placement of the seal cartridge assembly of the present disclosure;

FIG. 5B is an enlarged view in cross section of the seal cartridge assembly of the present disclosure as shown in FIG. 5A;

FIG. 6 is a perspective view of a shaft sleeve and stationary seal ring in accordance with a first aspect of the present disclosure;

FIG. 7 is an enlarged view in cross section of a rotodynamic pump illustrating the initial installation of a seal cartridge assembly in accordance with one aspect of the present disclosure;

FIG. 8 is an enlarged view in cross section of the rotodynamic pump shown in FIG. 7, depicting full installation of the seal cartridge assembly;

FIG. 9 depicts a shear pin in accordance with a first aspect of the present disclosure;

FIG. 10 depicts a shear pin in accordance with a second aspect of the present disclosure;

FIG. 11 depicts a shear pin in accordance with a third aspect of the present disclosure;

FIG. 12 depicts a shear pin in accordance with a fourth aspect of the present disclosure; and

FIG. 13 depicts a shear pin in accordance with a fifth aspect of the present disclosure.

### DETAILED DESCRIPTION OF THE INVENTION

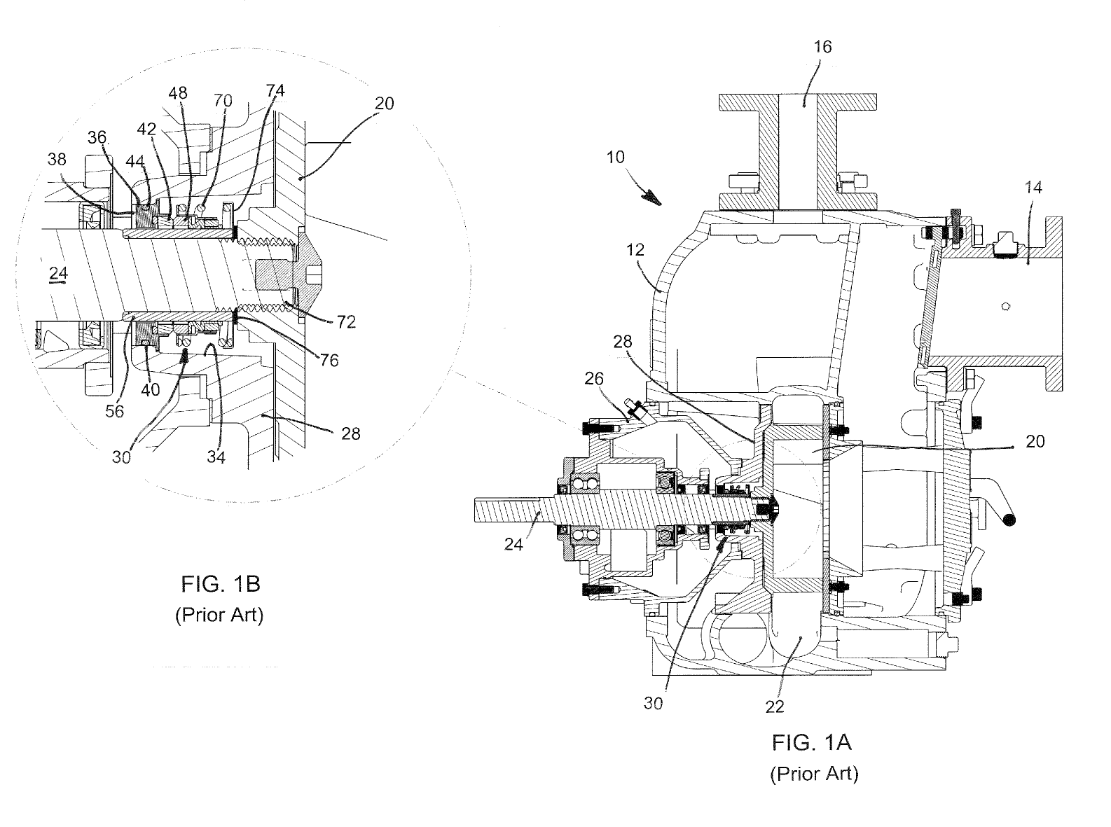

For the purposes of understanding the advantages of the seal cartridge assembly of the present disclosure, FIGS. 1 through 3 describe a first, conventionally-known method of installing a seal assembly. FIGS. 1A and 1B generally illustrate, by way of example, one type of centrifugal pump 10 comprising a pump casing 12 having an inlet 14 and a discharge 16. An impeller 20 is positioned within a pump chamber 22 formed by the pump casing 12. The impeller 20 is connected to a drive shaft 24 which extends through a bearing assembly or bearing housing 26. The drive shaft 24 is configured for operative engagement with a drive motor (not shown) to impart rotation to the drive shaft 24 and, thus, the impeller 20.

In the particular pump 10 depicted in FIG. 1A, a seal housing 28 is positioned between the pump casing 12 and the bearing housing 26, and provides a means for retaining a sealing arrangement 30. The sealing arrangement 30, as described more fully below, prevents the migration of fluid between the drive shaft 24 and the seal housing 28 or pump casing 12. A sealing housing may not always be part of the construction of a rotodynamic pump, and in some pump configurations, the sealing arrangement may be positioned against a part of the pump casing.

The seal housing 28, as shown in FIG. 1A, may be configured with a bell shape having a central recess 34 which is sized to receive the sealing arrangement 30. Referring to FIG. 1B, the sealing arrangement 30 generally comprises a non-rotating, or stationary, seal seat 36 which is positioned against an inner end wall 38 of the recess 34 of the stationary seal housing 28. As used herein, the term “non-rotating” is equivalent to the term “stationary” and may be used interchangeably. An o-ring 40 is positioned between the non-rotating seal seat 36 and the seal housing 28 inner wall 38 to prevent leakage between the drive shaft 24 and the seal housing 28. The non-rotating seal seat 36 is structured to retain and support a non-rotating seal member 42 in a manner that keeps the non-rotating seal member 42 stationary. An o-ring 44 is positioned between the seal seat 36 and the non-rotating seal member 42.

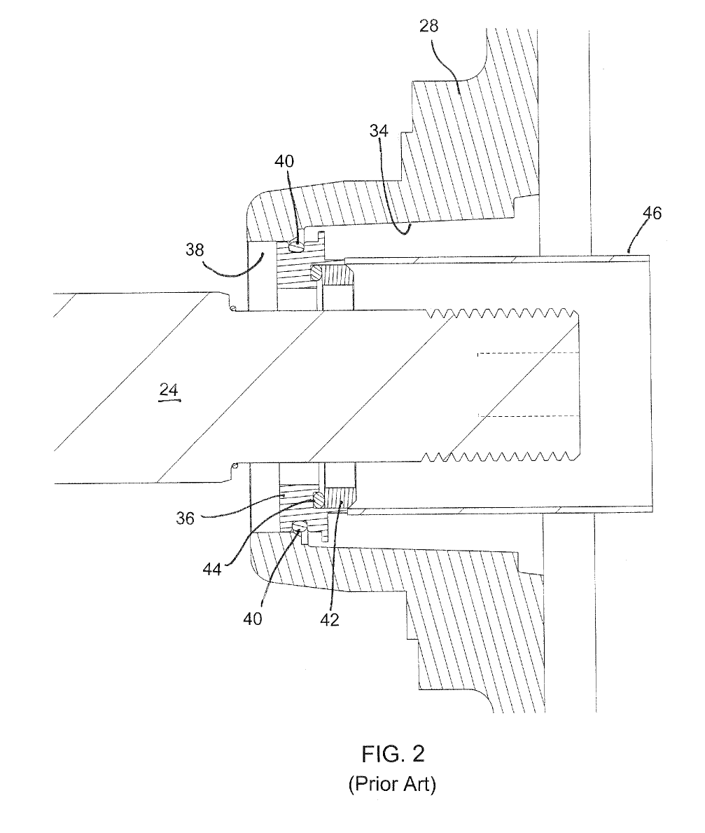

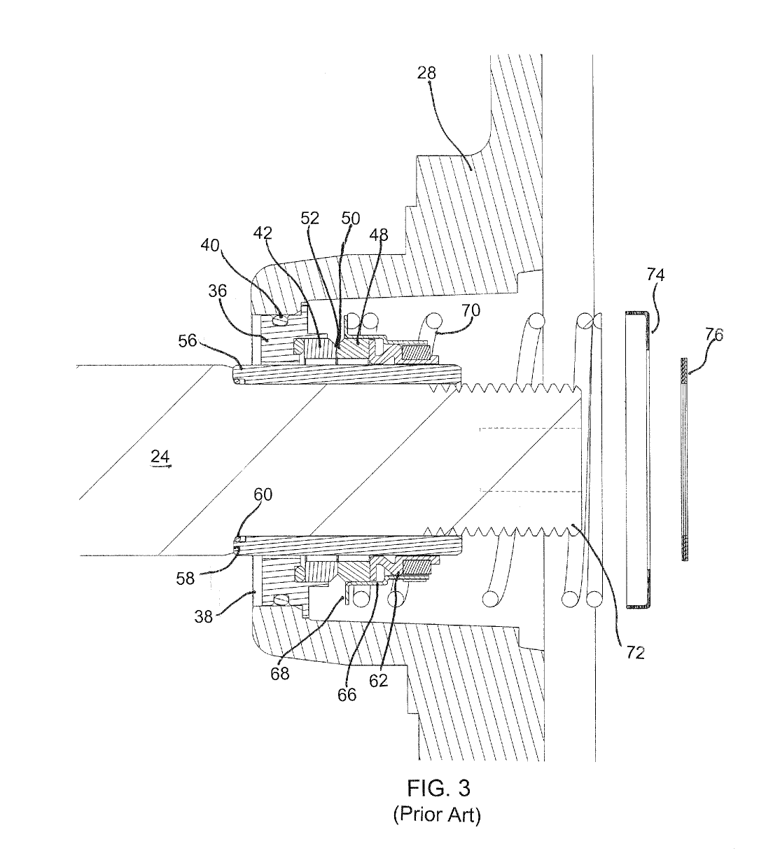

In the installation of this known type of sealing arrangement, illustrated in FIG. 2, the non-rotating seal seat 36 and non-rotating seal member 42 are positioned about the end of the drive shaft 24 and are advanced along the drive shaft 24 toward the end wall 38 of the seal housing 28 using a cylinder 46. As depicted in FIG. 3, after the cylinder 46 is removed, a rotating seal member 48 is then positioned about drive shaft 24, and the seal face 50 of the rotating seal member 48 is brought into adjacent position with the seal face 52 of the non-rotating seal member 42. The rotating seal member 48 is attached to a shaft sleeve 56 that engages the drive shaft 24. The shaft sleeve 56 is advanced along the drive shaft 24 until is abuts against a shoulder 58 formed on the drive shaft 24. An o-ring 60, prepositioned about the drive shaft 24, is situated between the shaft sleeve 56 and the drive shaft 24 to prevent leakage between the shaft sleeve 56 and the drive shaft 24.

A bellows member 62 is secured to the outer surface of the shaft sleeve 56, as shown in FIG. 3, which supports the rotating seal member 48. A cage 66 is further secured about the bellows member 62 and the rotating seal member 48, and is structured with a radially extending flange 68 that supports one end of a spring member 70 thereagainst. In this conventional method of positioning the sealing arrangement 30 about the drive shaft 24, the spring 70 is in a non-compressed state and extends past the terminal end 72 of the drive shaft 24.

To complete the installation, a centering washer 74 must be positioned against the spring 70 to bias the spring between the flange 68 and the centering washer 74. A fixing element 76 must then be positioned against the centering washer, and the spring must be manually compressed while the impeller 20, as shown in FIG. 1A, is installed on the terminal end 72 of the drive shaft 24 in known fashion. This type of conventional installation is extremely difficult to achieve given the parts of the sealing arrangement 30 and given the force that must be applied to compress the spring 70. FIG. 1A depicts the conventional structure in completely assembled mode.

In recognition of the difficulty that the aforementioned traditional installation presents, a pre-assembled cartridge for a seal assembly was proposed to facilitate the installation. An example of a cartridge seal assembly is disclosed and illustrated in U.S. Pat. No. 4,815,747 to Wolford, the contents of which are incorporated herein by reference. In the cartridge system of the '747 patent, the rotating seal member and non-rotating seal member, along with supporting elements, are affixed to a tubular support member that is sized to be positioned about the drive shaft of the pump. The assemblage of the tubular support member, seal members and other supporting elements is referred to as a cartridge seal.

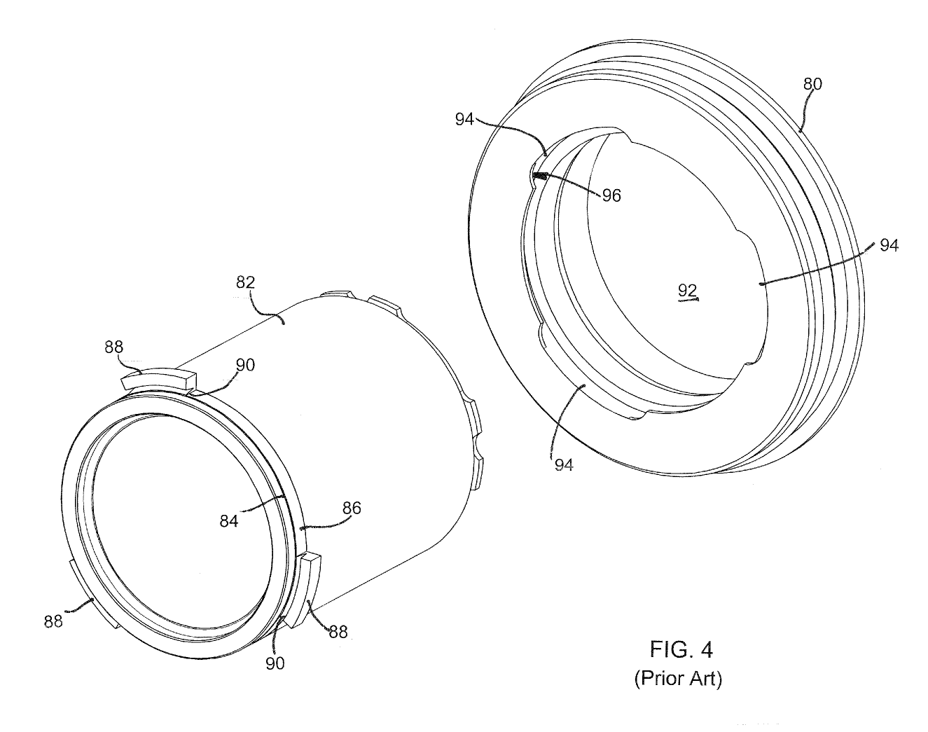

The cartridge seal of the '747 patent is structured such that a seal ring seat, which supports the non-rotating seal member and holds it stationary, is releasably secured to a tubular support member by a frangible mounting ring. FIG. 4 depicts the seal ring seat 80 and tubular support member 82 of the '747 patent. Notably, the non-rotating seal member, rotating seal member and supporting elements of the '747 patent are similar to those depicted in the sealing arrangement 30 of FIGS. 1-3 and are not depicted in FIG. 4.

The tubular support member 82 of the '747 patent is machined with a circumferential groove 84 into which a plastic ring 86 is positioned. The plastic ring 86 is formed with three radially-extending elongated tabs 88 that are arcuately shaped. Each of the elongated tabs 88 is formed with a notch 90 that extends along the edge of the elongated tab 88 at its point of connection to the plastic ring. The tubular support member 82 is sized in circumference to be received through the seal ring seat 80, which is ring shaped having a central opening 92. Arcuate slots 94 are formed about the inner circumference of the central opening 92 and are aligned to receive an elongated tab 88 of the tubular support member 82. A channel 96 is formed rearward of the slots 94 such that when the elongated tabs 88 are received in the slots 94, rotation of the tubular support member 82 relative to the seal ring seat 80 fixes the elongated tabs 88 within the channel 96.

In installation of the seal assembly, the tubular support member 82 is advanced along the drive shaft, which forces the seal ring seat 80 to move toward the end of the seal housing or pump casing until the seal ring seat 80 finally abuts against the inner wall of a housing, as earlier described herein. When the seal ring seat 80 is abutted against the housing, the force exerted upon the tubular support member causes the frangible elongated tabs 88 of the plastic ring 86 to break at the groove 90 and the tubular support member 82 continues to advance until is abuts the shoulder of the drive shaft, as previously described. This arrangement establishes a compressed state of the spring which surrounds the tubular support member and assures the engagement of seal faces between the rotating and non-rotating seal members.

It should be noted that the machining of a circumferential groove 84 in the wall of tubular support member 82 compromises the integrity of the wall of the tubular support member 82. Consequently, if a hard, solid object impacts against the impeller during operation of the pump, the axial force on the impeller can cause the tubular support member 82 to break at the site of the groove 84 causing the tubular support member 82 to collapse in an axial direction. As a consequence of the collapse of the tubular support member 82, the seal faces of the non-rotating and rotating seal members are no longer properly engaged and the seal fails.

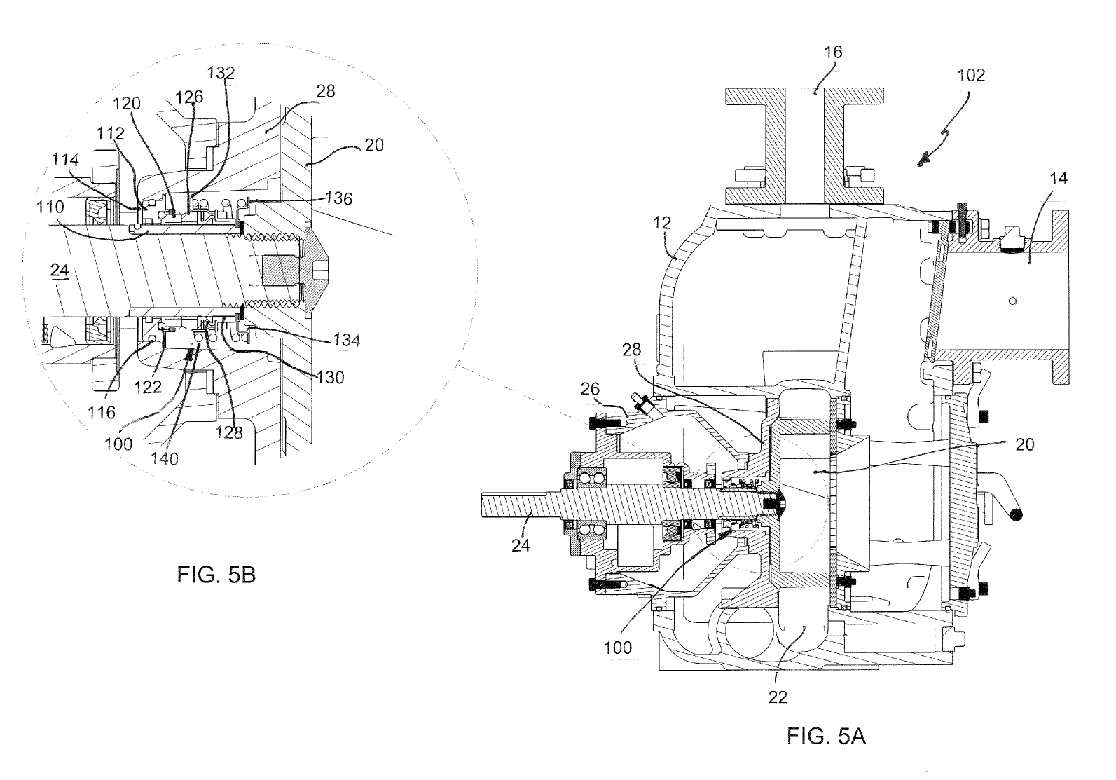

The seal cartridge of the present disclosure is directed to eliminating seal failure by providing a seal cartridge configuration that does not compromise the integrity of the supporting elements. FIGS. 5A and 5B illustrate the seal cartridge 100 of the present disclosure installed in a rotodynamic pump 102. For ease of comparative illustration, the same pump elements are shown in FIGS. 5A and 5B as are shown in FIGS. 1A and 1B, and are, therefore, designated by the same reference number. It should be noted, however, that the seal cartridge of the present disclosure is adaptable for use in any number or type of rotodynamic pumps.

FIG. 5B best illustrates the elements of the seal cartridge 100 of the present disclosure. The elements shown and described herein are by way of example and not meant to be limiting of the size, shape, dimension or number of elements in the assemblage. The seal cartridge 100 is shown positioned in a seal housing 28 that is part of or attached to the pump casing 12. A drive shaft 24 extends through an opening in the seal housing 28 and into the interior of the seal housing 28.

The seal cartridge 100 is comprised of a shaft sleeve 110 that is generally tubular and sized to be received on the drive shaft 24. The shaft sleeve 110 provides support for a stationary seal support ring 112, which is sized to be received in a recess 114 formed at the outer end of the seal housing 28. An o-ring 116 is positioned about the outer circumference of the stationary seal support ring 112 to prevent leakage between the stationary seal support ring 112 and the seal housing recess 114 wall. The stationary seal support ring 112 is structured to secure a stationary seal member 120 in fixed arrangement relative to the drive shaft 24. An o-ring 122 is positioned between the stationary seal member 120 and the stationary seal support ring 112 to prevent leakage therebetween.

The seal cartridge 100 further includes a rotating seal member 126 that is secured to the shaft sleeve 110 by a support bracket ring 128 that encircles the shaft sleeve 110 and is affixed to the shaft sleeve 110 so that the support bracket ring 128 and rotating seal member 126 rotate with the rotating drive shaft 24. An annular flanged ring 130 is also affixed to the support bracket ring 128, and is provided with a radially-extending flange 132. The shaft sleeve 110 is further structured to support a centering ring 134 that is also structured with a radially-extending flange 136. A compression spring 140 is biased between the flange 132 of the annular flanged ring 130 and the flange 136 of the centering ring 134.

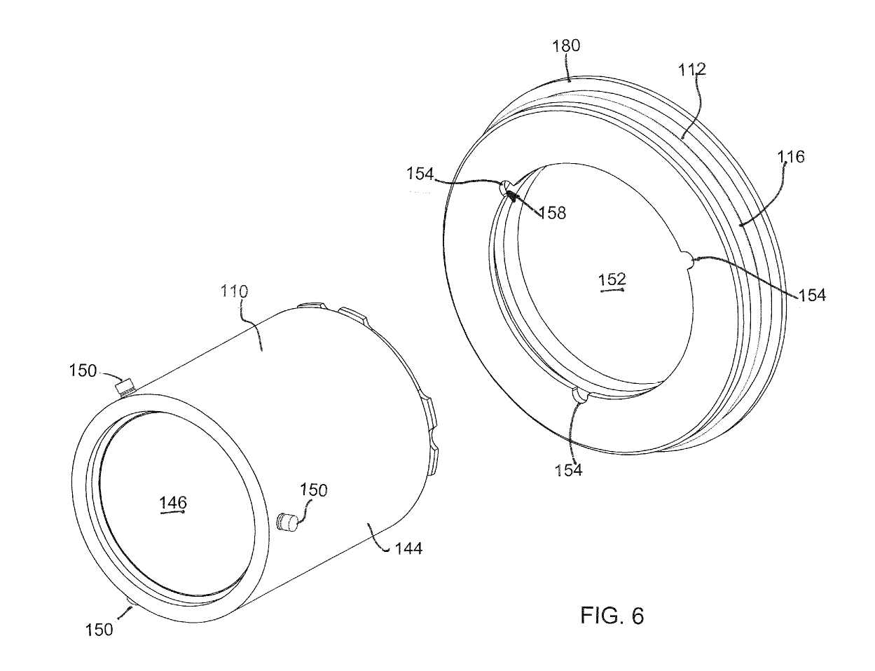

As better seen in FIG. 6, the shaft sleeve 110 of the seal cartridge 100 is formed as a cylindrical body 144 having a hollow center bore 146 which is sized to be received on the drive shaft. A plurality of shearable pins 150 are positioned to extend radially outwardly from the outer wall surface 146 of the cylindrical body 144. The stationary seal support ring 112 is structured as a ring having a central opening 152 sized to receive the cylindrical body 144 of the shaft sleeve 110 therethrough. The inner circumference of the central opening 152 is structured with pin slots 154 arranged and sized to receive a shearable pin 150 therein. A channel 158 is formed in the stationary seal support ring 112 rearward of the pin slots 154. As the cylindrical body 144 passes through the central opening 152 of the stationary seal support ring 112, the shearable pins 150 are aligned with and received in the pins 150 in the pin slots 154. The stationary seal support ring 112 is then rotated relative to the shaft sleeve 110 to position the shearable pins 150 within the channel 158, thereby providing a surface against which the shearable pins 150 bear during installation.

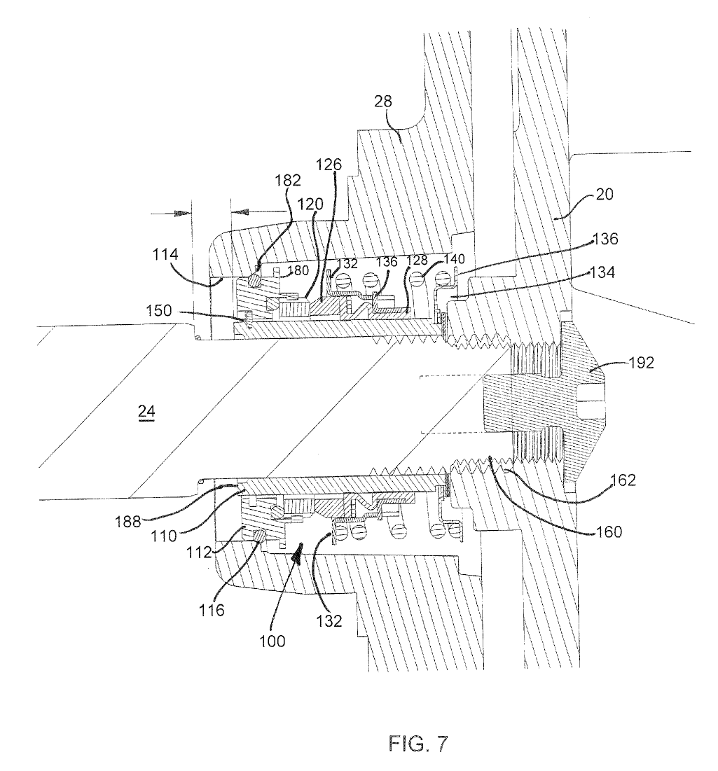

FIG. 7 illustrates the seal cartridge 100 of the present disclosure as it is being installed on the drive shaft 24. The seal cartridge 100 is advanced onto the drive shaft 24, followed by positioning of the impeller 20 on the terminal end 160 of the drive shaft 24. The terminal end 160 of the drive shaft 24 is threaded and the central bore 162 of the impeller 20 is correspondingly threaded to affix the impeller 20 to the drive shaft 24. As the impeller 20 is rotated on the drive shaft 24 to threadingly attach the former to the latter, the advancement of the impeller 20 onto the drive shaft 24 forces the seal cartridge 100 to be advanced farther onto the drive shaft 24 until the stationary seal support ring 112 contacts the inner recess 114 of the seal housing 28. Continued securement of the impeller 20 on the drive shaft 24 exerts a force on the shaft sleeve 110 which, in turn, forces the stationary seal support ring 112 to move farther into the recess 114.

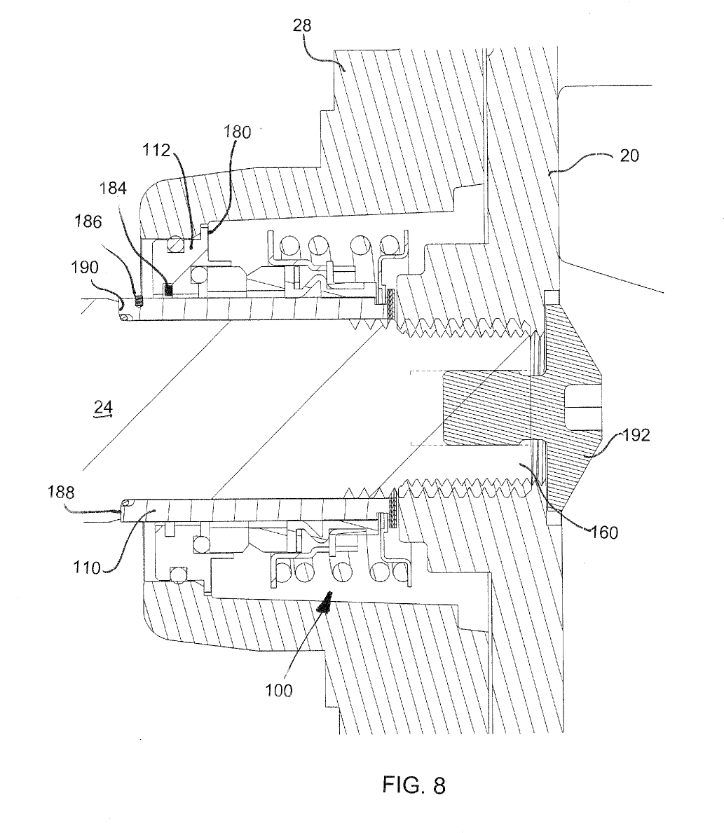

When the flanged edge 180 of the stationary seal support ring 112 contacts the shoulder 182 of the seal housing 28, the force exerted by the impeller 20 reaches a determined load at which point the shearable pins 150 shear, as illustrated in FIG. 8, leaving one portion 184 of the shearable pin 150 in the stationary seal support ring 112 and leaving another portion 186 of the shearable pin 150 in the shaft sleeve 110. Continued threaded attachment of the impeller 20 on the drive shaft 24 forces the shaft sleeve 110 to advance further until the end 188 of the shaft sleeve 110 contacts an inward shoulder 190 of the drive shaft 24. Installation is completed by threaded attachment of an impeller bolt 192 to the drive shaft 14 in known fashion.

The use of shearable pins 150 as a means of attaching the shaft sleeve 110 to the stationary seal support ring 112 for positioning of the seal cartridge 100, as described above, has the advantage over previous arrangements in that the integrity of the shaft sleeve 110 is not compromised as a result of fixing the shearable pins 150 to the shaft sleeve 110. It should be understood that the shaft sleeve 110 is made of a metal material, such as stainless steel or an alloy, while the shearable pins 150 are made of a more shearable material, such as plastic or other materials having a desired shear force. Since the forces exerted by the impeller 20 on the drive shaft 24 are typically in the range of 100 pounds to 300 pounds, the use frangible devices that are more substantially constructed presents a seemingly better means of supporting the stationary seal support ring 112 on the shaft sleeve 110 because premature breakage of the frangible devices is to be avoided. That is, premature breakage of the frangible devices can result in an unbalanced load being exerted on the seal assembly, which compromises the efficacy of the seal.

Therefore, the use of small shearable pins 150 in the present seal cartridge presents particular structural challenges not anticipated by more substantially constructed frangible devices. In a particularly suitable configuration of the seal cartridge 100, the shaft sleeve 110, which has a wall thickness of about 0.125±0.002 inches, is machined with blind holes to a depth of about 0.105 inches±0.002. As used herein, “blind holes” refers to holes that have a bottom surface and which do not extend through the wall of the shaft sleeve. The shearable pins 150 are made of a material that has a shear strength of between 7300 and 7900 psi at 73° F. Materials that may be particularly suitable are thermoplastics having the requisite shear strength, although other non-plastic materials are also suitable.

The shearable pins 150 may be sized and configured in a number of suitable shapes or configurations. One particularly suitable configuration is shown in FIG. 6 and FIGS. 9 and 10 where the shearable pin 150 is a solid cylinder shape. The shearable pins 150 of this configuration may have a length of between about 0.230 inches and 0.255 inches, and may have a diameter of between about 0.105 inches and 0.135 inches. It has been found that at these dimensions, the shearable pins 150 have structural strength sufficient to bear a considerable load, but will then appropriately shear at between about 200 pounds and 260 pounds of shear force, depending on the size of the shaft sleeve 110. The dimensions of the shearable pins 150 may vary, however, depending on the size of the pump and the associated drive shaft and impeller dimensions. The dimensions of the shearable pins 150 may also be influenced to some degree by the selected material of construction and the shear strength of the material.

The number of shearable pins 150 that may be employed with the shaft sleeve 110 may vary as well. No less than three shearable pins 150 is preferred in order to provide proper balancing of the stationary seal support ring 112 and associated seal elements. A greater number of shearable pins 150 may be used, such as between four and six pins, but maintaining proper balance is a critical consideration. In a particularly suitable aspect of the seal cartridge, three shearable pins 150 are employed, and are spaced evenly about the circumference of the shaft sleeve 110. Three shearable pins 150 assures that the stationary seal support ring 112 is properly balanced and that all of the shearable pins 150 shear at the same time to assure proper positioning of the seal elements of the seal cartridge.

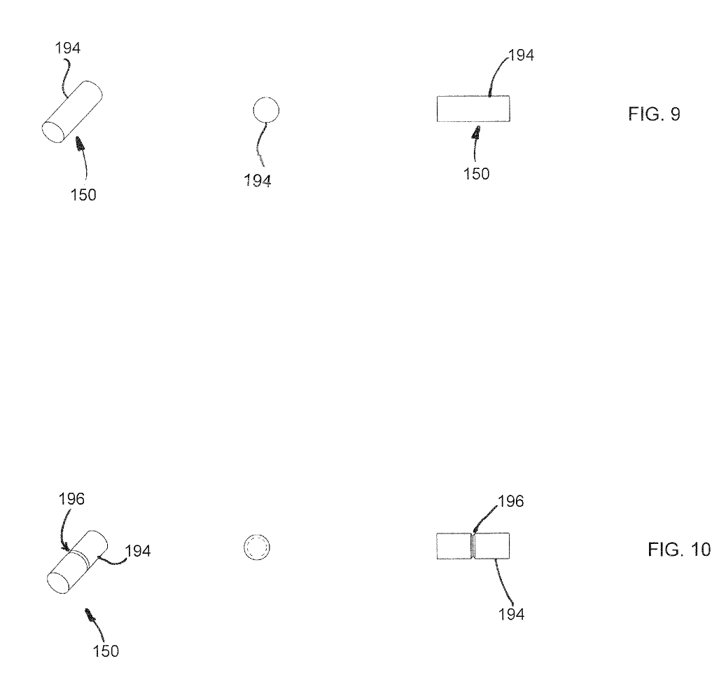

FIG. 9 illustrates a first aspect of a shearable pin 150 that is configured as a solid cylinder having a solid cylindrical body 194. Shearable pins 150 of this configuration may be particularly suitable since they have been found to provide especially beneficial shear loading. FIG. 10 illustrates a second aspect of a shearable pin 150 being configured as a solid cylindrical body 194, but being formed with a circumferential groove 196 about the circumference of the cylindrical body 194 which provides a point of shearing of the shearable pin 150. Notably, the shaft sleeve 110 may be structured with a plurality of shearable pins 150, each being of a common construction, such as the shearable pins 150 shown in FIG. 9; or the plurality of shearable pins 150 may comprise a mixture of various types of pin configurations, including the configurations shown in FIGS. 9 and 10, as well as other pin configurations.

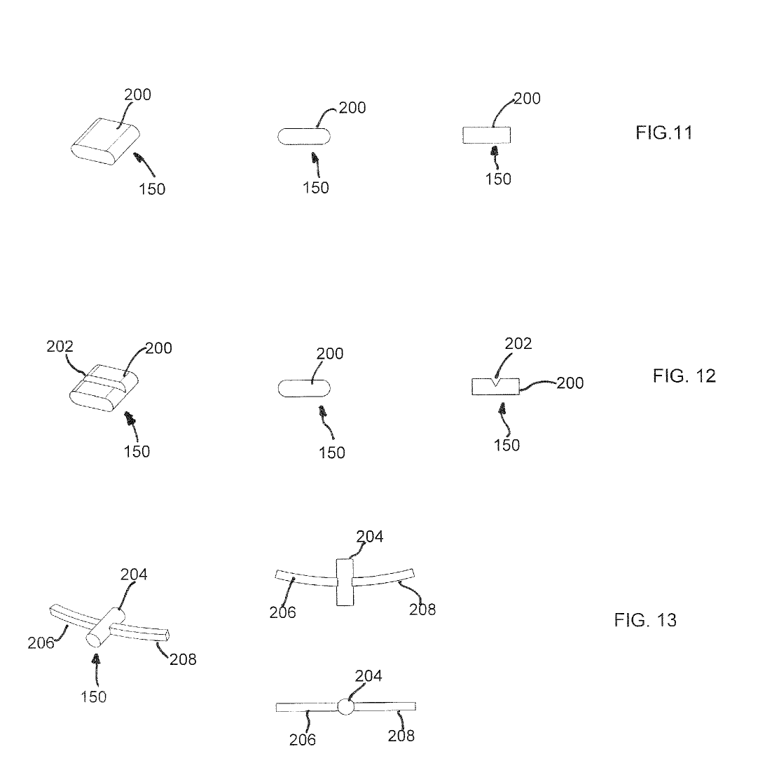

FIG. 11 illustrates another aspect of a shearable pin 150 where the shearable pin 150 is formed as a substantially square tablet 200 having, in cross section, an oblong shape. The corresponding hole formed in the shaft sleeve would, therefore, by oblong in configuration. FIG. 12 illustrates yet another aspect of a shearable pin 150 where the shearable pin 150, as shown in FIG. 11, is formed as a square tablet 200 having a groove 202 formed in one side. The groove 202 provides a point of shearing.

FIG. 13 illustrates yet another aspect of a shearable pin 150 which is constructed with a solid cylinder 204 having arcuate wings 206, 208 extending outwardly from the cylinder 204. This configuration of a shearable pin 150 may be particularly suited for use in a shaft sleeve 110 that may be used to repair or replace the seal arrangement of an existing pump having a seal ring support that may accommodate the shearable pin 150 shape as shown in FIG. 13.

FIG. 9 through FIG. 13 illustrates a variety of shearable pin shapes and dimensions that may be employed in the present invention. The illustrated shearable pin designs are not intended to be an exhaustive inventory of possible shapes, sizes, dimensions or number of pins.

The shearable pins 150 have been described herein as being separately formed from and inserted into holes formed in the shaft sleeve 110. However, it may also be possible to form a shaft sleeve, such as by molding or machining techniques, that has shearable pins integrally formed with the shaft sleeve.

The seal cartridge of the present disclosure is configured to facilitate the installation of a seal arrangement in a rotodynamic pump, as described herein, while maintaining the integrity of the seal. The elements of the seal cartridge, particularly with respect to the rotating and non-rotating seal members and the associated devices for securing those seal members to the shaft sleeve, are by way of example only. Any number of modifications to the seal members may be made, or different sealing elements employed in carrying out the seal cartridge of the disclosure. Thus, reference to particular details of the seal cartridge described and illustrated herein are by way of illustrative example and are not meant to limit the scope of the invention as set forth in the claims.

What is claimed is:

1. A seal cartridge for installing a sealing arrangement in a rotodynamic pump to seal non-rotating elements of the pump from rotating elements of the pump, comprising:
a shaft sleeve sized to be received on the drive shaft of a rotodynamic pump, the shaft sleeve having an outer surface and a circumference, and having a plurality of blind holes formed in said outer surface about said circumference;
a stationary seal support ring configured to support and retain a non-rotating seal member;
a non-rotating seal member;
a rotating seal member positioned relative to the shaft sleeve; and
a plurality of shearable pins received in said plurality of blind holes formed in said shaft sleeve, said shearable pins being oriented to extend radially outward from said outer surface of said shaft sleeve and being configured to engage said stationary seal support ring.

2. The seal cartridge according to claim 1, wherein said plurality of shearable pins comprises three shearable pins.

3. The seal cartridge according to claim 2, wherein said three shearable pins are spaced evenly about said circumference of said shaft sleeve.

4. The seal cartridge according to claim 1, wherein said plurality of shearable pins are configured as a solid cylinder.

5. The seal cartridge according to claim 4, wherein said at least some of said plurality of shearable pins are structured with a groove about a circumference of said solid cylinder thereof.

6. The seal cartridge according to claim 1, wherein said plurality of shearable pins have a non-cylindrical shape in cross section.

7. The seal cartridge according to claim 6, wherein said plurality of shearable pins are configured as a substantially square tablet.

8. The seal cartridge according to claim 7, wherein said plurality of shearable pins are configured with a groove formed in one long surface of said substantially square tablet.

9. The seal cartridge according to claim 1, wherein said plurality of shearable pins are configured with a cylindrical body having two arcuate wings extending outwardly from said cylindrical body.

10. The seal cartridge according to claim 1, wherein said plurality of blind holes formed in said outer surface of said shaft sleeve have a depth of between about 0.105 inches±0.002.

11. The seal cartridge according to claim 1, wherein each shearable pin of said plurality of shearable pins has a length of between about 0.230 inches to about 0.255 inches.

12. The seal cartridge according to claim 1, wherein each shearable pin of said plurality of shearable pins has a diameter of between about 0.105 inches and about 0.126 inches.

13. The seal cartridge according to claim 1, wherein each shearable pin of said plurality of shearable pins has a shear load of between about 200 pounds and 260 pounds.

14. The seal cartridge according to claim 1, wherein each shearable pin of said plurality of shearable pins is formed of a material having a shear strength of between 7300 and 7900 psi at 73° F.

15. The seal cartridge according to claim 14, wherein said shearable pins of said plurality of shearable pins are made of thermoplastic material.

16. A shaft sleeve for a seal cartridge assembly used for installing a sealing arrangement in a rotodynamic pump to seal non-rotating elements of the pump from rotating elements of the pump, comprising a tubular body having an outer surface and a circumference, and having a plurality of shearable pins attached to said outer surface oriented to extend radially outwardly from said outer surface, said plurality of shearable pins being evenly spaced about the circumference of said tubular body and being made of a material having a shear strength of between 7300 and 7900 psi at 73° F.

17. The shaft sleeve of claim 16 wherein said shearable pins are received in blind holes formed in said outer surface of said tubular body.

18. The shaft sleeve of claim 16, wherein said plurality of shearable pins comprises three shearable pins.

19. The shaft sleeve of claim 18, wherein at least some of the shearable pins of said plurality of shearable pins are formed with a groove along a surface of the shearable pin.

20. The shaft sleeve of claim 16, wherein said plurality of shearable pins has a shear load of between 200 pounds and 260 pounds.
